(19) United States
(12) Patent Application Publication
(10) Pub. No.: US 2013/0166422 A1
(43) Pub. Date: Jun. 27, 2013

(54) System and Method of Financial Reconciliation and Attribution for Businesses and Organizations

(71) Applicant: Jagjit Singh Soni, Centreville, VA (US)

(72) Inventor: Jagjit Singh Soni, Centreville, VA (US)

(21) Appl. No.: 13/776,033

(22) Filed: Feb. 25, 2013

Related U.S. Application Data
(60) Provisional application No. 61/710,070, filed on Oct. 5, 2012.

(51) Int. Cl. G06Q 40/00

(52) U.S. Cl. CPC G06Q 40/10
USPC 705/30

(57) ABSTRACT

Provided is a disbursement tracking system for organizations, government entities and the like. The system is a financial accounting platform that facilitates disbursement of funds to specific recipients within an organization and performs error checking to ensure that only the addressee takes control of the funds. This is accomplished through the creation of an address label which is affixed to the disbursement in the form of a concatenated bit pattern in a funds file, or a separate disbursement record file containing relevant identifying information. Address label information will include a sender identifier, an address identifier, a disbursement amount, and optionally an optional reference number associated with an allocation or budget proposal. When the disbursement is received by a department or project manager, the system checks the address label against the department's identifier for a match. A correct match results in attribution of the funds to the recipient's available funds total.

### CROSS REFERENCE TO RELATED APPLICATION

This application claims the benefit of U.S. Provisional Application No. 61/710,070 filed on Oct. 5, 2012, entitled “Fund Control Using Tracking.” The above identified patent application is herein incorporated by reference in its entirety to provide continuity of disclosure.

### BACKGROUND OF THE INVENTION

1. Field of the Invention

The present invention relates to accounting tools and methods of transferring funds when from one source to a recipient using logistics principles. More specifically, the present invention pertains to an accounting tool that tracks the movement and location of funds with an organization and associated organizations using shipment tracking principles such that the source, intended location, actual location, and the destination is known for a given set of funds for accounting and for reducing the burden of funds reconciliation.

Large organizations and government entities face difficult problems in maintaining proper accounting records. These organizations are often made up of many departments or divisions, each having its own goals, tools, and fiscal concerns. Bookkeeping for a first department may be simple and only involve procurement of funds for purchase and maintenance of machinery, and meeting payroll. Conversely, another department may have a number of field employees who need per diem allotments, travel reimbursement, conference enrollment costs, and training tuition, in addition to meeting payroll. Still another department may have substantial fluctuating research costs including changing personnel, equipment acquisition, laboratory set up, purchase of odd quantities of materials and payroll. Substantial variation in funds usage practices make it difficult for financial overseers to keep track of how money is spent within the organization.

In most companies or government organizations, accounting is handled by a Chief Financial Office(r) that coordinates with individual departments. Funds are disbursed from the CFO to departments based on proposed budgets or allotments for the previous fiscal period. Each department will generally perform internal accounting to monitor funds usage by individual employees or projects. At the end of a fiscal period the CFO will attempt to reconcile the allotted disbursements with actual expenditures by the department. The larger the organization and its departments, the more difficult this task becomes.

Funds can easily be lost or misappropriated as they make their way down the chain of allotments from the CFO to an individual employee. By way of example, an organization may choose to allot one million dollars to a research and development department based on its proposal that it will need one hundred thousand dollars per project for ten projects. The CFO makes this allotment and disburses the funds to the research and development department. But, when the department receives notice of the allotment, it realizes it only needs fifty thousand for one project and decides to split the leftover money and give it to two other projects. The next fiscal period, research and development submits a proposal for another one million dollars but this time the proposal is based on usage for the prior fiscal period, i.e., fifty thousand for one project, one hundred twenty five thousand for two projects, and one hundred thousand for seven projects. While this proposal seems fair and is an honest representation of expenditures, it will not match up with the CFO's records of allotments for the prior fiscal period. Reconciliation discrepancies such as this, though non-criminal, can cause a lot of wasted time and effort for the company, while the mystery is solved.

Current accounting systems log allotments and disbursement and then try to match them up with expenditures. Discrepancies are reconciled through careful investigation of the chain of custody associated with a disbursement. This is time-consuming, and may end up costing more in the amount the company pays the investigator than the discrepancy is worth. Further, some reconciliation problems cannot be solved because there is no record of where the money actually went, or how it was spent on a particular project. A financial accounting system is needed that tracks disbursements as they move through the organization and ensures that funds reach their target destination.

2. Description of the Prior Art

Systems have been disclosed in the prior art that relate to accounting and funds tracking. These include systems that have been patented and published in patent application publications. These systems generally relate to financial tracking and accounting. The following is a list of systems deemed most relevant to the present disclosure, which are herein described for the purposes of highlighting and differentiating the unique aspects of the present invention, and further highlighting the drawbacks existing in the prior art.

U.S. Pat. No. 7,873,576 to Jones discloses a financial document processing system that accepts deposits and withdrawals and scans a plurality of documents to obtain their images for further processing. From the images, the denomination and serial numbers of the currency is derived and compared to a given input. The system compares the derived deposit amount with the given input to determine if a discrepancy exists for further investigation. While related to a system for accounting purposes, the Jones device is an automated teller device that utilizes image processing as a means to accept deposits. The present system and method involves larger transactions and enterprise accounting.

U.S. Pat. No. 5,745,886 to Rosen discloses a system for facilitating the distribution of electronic money and ensuring the transaction or money exchange is both secure and tracked during the exchange. The system proffers to provide a tamperproof means of transferring electronic funds from one trusted agent to another using cryptography and steps that ensures an authorized transaction occurs and the money exchanges between the two parties as desired. As with Jones, the Rosen device offers a system having diverging qualities and function, wherein the Rosen device relates to secured money transactions between customers and merchants rather than an accounting tool for large entities and organizations.

U.S. Pat. No. 6,065,672 to Haycock discloses a system and method for currency distribution, tracking and management. The system tracks the last distribution information of individual currency notes as they travel through the world. Individual notes are tracked via their unique identifiers and a distribution history is maintained for each unique identifier. As notes move through the financial system their distribution is logged, creating an accumulated history of the note's circulation. This system is useful for tracking the lifecycle of individual physical notes, but does not describe a way of tracking electronic funds disbursements as they move through an organization.

Another currency bill tracking system is described in Jones, U.S. Pat. No. 7,903,863. The system contemplates scanning of currency notes deposited at financial institutions, storefronts, or casinos. The serial number of the notes is logged and added to a local log history. Images of the scanned notes may also be retained. These serial numbers and images are associated with a transaction within a database that may be local or remote. Usage history of individual currency bills can thus be tracked as they travel through the financial system. Jones discloses the use of this system for aiding law enforcement officials in tracking funds used in criminal activity. Like the Haycock system, Jones disclosed a system and method of tracking physical currency notes. It does not contemplate tracking and proper routing of electronic funds within a large organization. The present invention provides a system for tracking disbursements and ensuring that they are utilized by the intended recipient.

The prior art systems listed herein suffer from several known drawbacks. They do not guarantee that the funds will be received y the intended party or that the party making the deposit is the intended recipient. The present invention discloses a system in which a disburser and a recipient are known at the time the money is released, and is tractable until attributed to the account of the intended recipient. It substantially diverges in design elements from the prior art and consequently it is clear that there is a need in the art for an improvement to existing funds attribution and reconciliation systems. In this regard the instant invention substantially fulfills these needs.

### SUMMARY OF THE INVENTION

In view of the foregoing disadvantages inherent in the known types of funds tracking systems now present in the prior art, the present invention provides a new disbursement tracking system, wherein the same can be utilized for providing convenience for the user when reconciling accounting discrepancies

The present invention provides a financial system that accounts for funds allotments and disbursements as they travel between sub-organizations of a company, government entity, or the like. A software platform including administrator and client interfaces, one or more databases, and transactional programming, operates on one or more servers and a plurality of client computers, connected via a network. Disbursements are made by a Central Financial Officer via the administrator interface to various departments via client interfaces. These disbursements are specifically addressed to the individual department and cannot be utilized or accepted by anyone other than the recipient.

Disbursement recipients can redistribute funds to individuals within their sub-organization. Department heads can thus distribute a portion of their budget to various projects, per diems, travel expenses, material acquisitions, and individuals as necessary. The funds expenditures attributed to each terminating point in the chain of custody can be tracked back up to the CFO, making reconciliation easy and inexpensive.

It is therefore an object of the present invention to provide a new and improved disbursement tracking system that has all of the advantages of the prior art and none of the disadvantages.

It is another object of the present invention to provide a system that tracks funds allocations and disbursements from the initial disbursement down to the final recipient.

Another object of the present invention is to provide a system that provides easy reconciliation of expenditures to the original budget allocations.

Still another object of the present invention is to provide a system that reduces the risk that disbursements will be misappropriated.

Yet another object of the present invention is to provide a system that attributes funds only to the intended recipient.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system diagram of a first embodiment of the disbursement tracking system.

FIG. 2 shows a system diagram of a second embodiment of the disbursement system

FIG. 3 shows a general configuration of a server or client computer

FIG. 4 shows a flow diagram of a sample transaction made within the disbursement system.

FIG. 5 shows a flow diagram of the disbursement initialization and transmission process.

FIG. 6 shows a flow diagram of an alternative embodiment of the disbursement initialization and transmission process.

FIG. 7 shows a flow diagram of an embodiment of the address label error checking process.

FIG. 8 shows a flow diagram of an embodiment of the attribution process.

FIG. 9 shows a flow diagram of an alternative embodiment of the address label error checking and attribution processes.

FIG. 10 shows a flow diagram of an alternative embodiment of the address label error checking and attribution processes.

### DETAILED DESCRIPTION OF THE INVENTION

Reference is made herein to the attached drawings. Like reference numerals are used throughout the drawings to depict like or similar elements of the disbursement tracking system. For the purposes of presenting a brief and clear description of the present invention, the preferred embodiment will be discussed as used for tracking track of expenditures and allocations within organizations. The figures are intended for representative purposes only and should not be considered to be limiting in any respect.

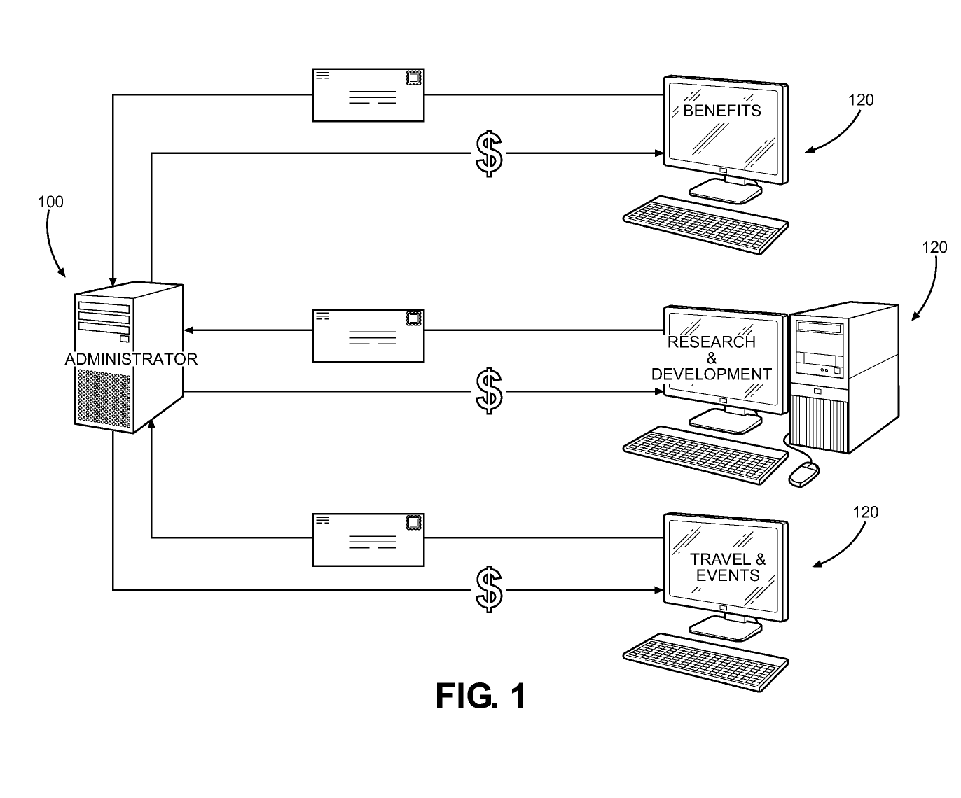

Referring now to FIG. 1, there is shown a diagram of a disbursement tracking system. The system provides a means for government entities, corporations, large charities, and other organizations to reconcile budget allotments with expenditures. Disbursements made by the Chief Financial Office(r), Bursar,

Comptroller, or other financial officer are directed to specific recipients within an organization. An administrator interface 100 is used to create and disburse funds to departments 120. The software platform logs the transmission and receipt of funds allocations and ensures that they are attributed to the proper departments. Much like a package tracking system, the funds tracking software creates address labels for disbursements, checks for proper delivery and sends notice to the sender of delivery failure or confirmation.

Administrative users enter organizational budget information into the administrator interface either by manual input or by accepting budget proposal files from departments. Budget proposals are well known in the art of organizational finance as expenditure projections for a given financial period. They will generally include estimates on payroll expenses, major projects, and equipment purchases, as well as slush fund costs. Each financial period, proposals are submitted to the appropriate organizational authority for approval.

In the present system, the budget is approved within the administrator interface and the application then adds the information to a budget database. Information on proposed expenditures of each department is then available to the administrator for look-up. The decision to limit budget information to overall expenditures of projects/employees or to monitor individual purchases is up to the organization, and the system contemplates both accountability depths.

Once budgeting for a financial period is formalized by the organization's financial officer funds can be allocated from the organization's budget to each department according to their budget proposals. In most organizations, disbursements are made as needed, to facilitate proper correlation between disbursements and expenditures. This technique attempts to match up proposed events with end results, without accountability for interim events. Conversely, the present invention releases funds only upon assurance of proper delivery to a specific recipient, based on specific proposals. Because the system checks receipt and logs attribution at each step of the fiscal chain of custody a transaction history exists for each disbursement, making reconciliation easy.

The present disbursement system does this by creating “address label” files for each disbursement. Address labels may be separate files, or bit patterns concatenated to the disbursement transaction file itself. Identifying information about the sender, general recipient, amount, and optionally a specific recipient and budget proposal identifier, will be included in the address label. An administrator will input this information or import it from the budget database during disbursement initialization. Unique identifiers are assigned to each department and sub-unit within the organization so that senders and addresses can be easily associated with particular departments.

Some organizations may hold only one or a couple bank accounts, for general organizational use as filtered by the financial officer. Others may have individual accounts for each department, and shift funds into these accounts as necessary.

In FIG. 1, the system is shown in an organization that employs one or a couple of general accounts. Because the funds are in a pool, there is no need for actual shifting of funds between the organization's accounts. Thus, all disbursement transactions happen within the disbursement tracking system. Funds disbursements are initiated, address labels created, and the funds are “sent” to their addressees, who in turn notify the financial officer of proper receipt and attribution. This is all record keeping for accounting and reconciliation purposes.

Each department is responsible for ensuring that their disbursements match with individual purchases. This is easily done within the client interface which accepts input of individual expenditures and prompts the user to designate the disbursement pool used. Permission must be given from the financial officer before funds can be used from one pool to add to another. In this manner companies can easily track funds down to individual projects and teams of employees, making it easy to figure out who is responsible for discrepancies, and thus easier to sort inconsistencies out.

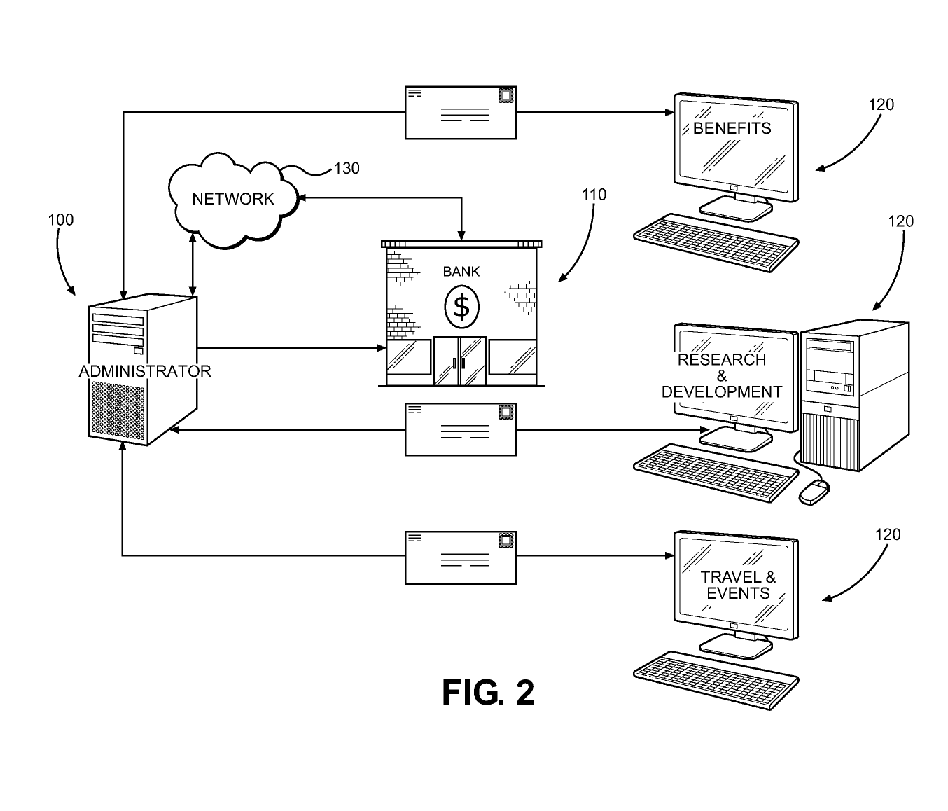

Turning to FIG. 2 there is shown a diagram of the disbursement system at an organization that employs diversified bank accounts. Because money must actually be shifted between accounts during disbursals, a financial institution 110 is contacted via the Internet 130 or other network.

Once the financial officer initiates a disbursement, creates an address label, and transmits the disbursement via the administrator terminal 100, the address label is sent to the addressee department 120, project, or individual. Upon receipt the client interface checks to ensure that the addressee matches the recipient before attributing the funds. If attribution is achieved the bank is given an electronic funds transfer request to shift the actual funds between accounts. A second error checking may be used to ensure that the funds were properly transferred. Notice will be send to the sender, providing delivery confirmation. A bank transaction history and a delivery history will be maintained in a transaction database to assist in reconciliation. The timing of the address label error checking and electronic funds transfer process will be discussed in detail below, and can happen in multiple embodiments.

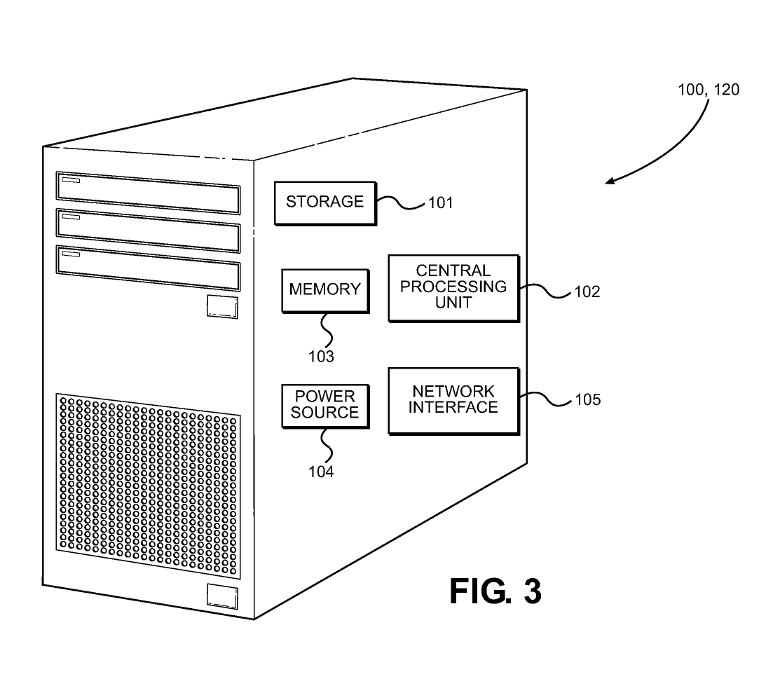

Referring now to FIG. 3 there is shown an exemplary server or client computer. The system depends upon at least one administrator interface, and one or more client interfaces. The administrator interface may be run on the server that hosts the budget and transaction databases or may be run on a workstation separate from the database server. Each of the essential components will consist of a computer having a central processing unit 102, a memory 103, a storage/machine readable medium 101, a network interface 105 and a power source 104. These computers will communicate over a network such as the Internet, a local area network, a wireless local area network, a wide area network, or the like. Basic network configuration is well known to those of ordinary skill in the art, and it will be obvious to such a person that the configuration of the present system may be manipulated while still providing the needed components

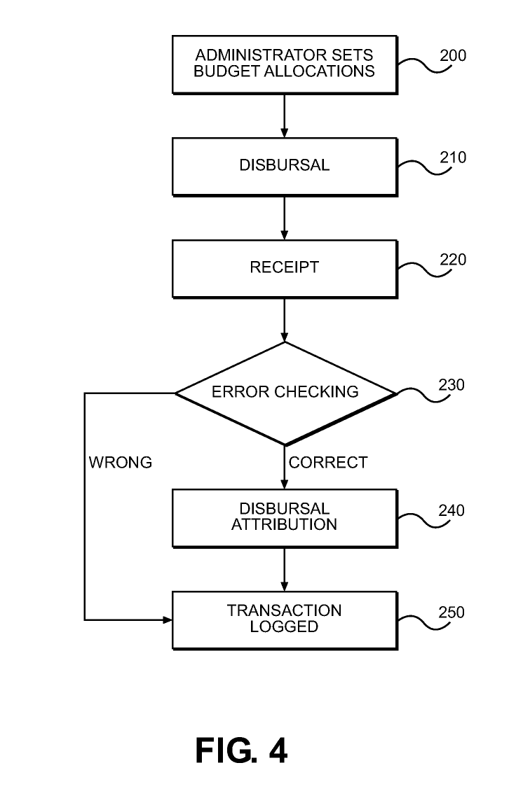

A flow chart of the overall process occurring between disbursement creation and attribution is shown in FIG. 4. First the Chief Financial Officer or other administrator builds a budget for the financial period 200, based on proposals of various departments. Details regarding the creation of the budget are unnecessary as Organizational budget creation is well known in the art and their optimization is beyond the scope of this disclosure.

Disbursals are then made 210 to different departments at pre-determined times. For example, pay roll may be released once a month, equipment acquisition funds may be disbursed upon ordering of machinery, and so on. When the disbursal is initialized, the administrator will input the unique identifier of the sender, the unique identifier of the recipient(s), amount of disbursal, and any identifiers associated with a particular project, allocation, or budget proposal. The funds are sent to the address on the disbursement address label.

Received disbursements are kept in a “mailbox””, that is a directory used for temporary storage of pending disbursements. Once the disbursement is received by the address 220 it will be held in the mailbox associated with the department until proper delivery is confirmed. This error checking process 230 may happen automatically, as soon as new files appear in the mailbox or upon user input. Automatic processing is preferred; however some organizations may desire that an employee acknowledge receipt of the funds, much like signing for a package.

Error checking 230 is performed by the client interface part of the accounting software platform. When a disbursement is received in the mailbox, or when a user acknowledges receipt, the system reads the address label information and attempts to match the addressee identifier with the identifier of the actual recipient. Each mailbox is associated with a particular organizational identifier so that the system can easily determine where a disbursement has been received. If the recipient identifier does match the addressee identifier as disclosed by the address label, the funds are added to the recipient's available funds balance 240. A delivery confirmation is added to the transaction database in the form of a disbursement log entry 250. Notice of delivery can optionally be sent to the sender, if redundant record keeping is desired.

If the identifiers do not match, no funds are attributed to the user's available funds balance. Notice is sent to the sender that delivery failed, and further action is prompted. A record of the incorrect delivery is added to the transaction database as a disbursement log entry 250. The send can choose to correct the address label so that the address identifier matches that of the recipient or may cancel the disbursement all together and create a new one addressed to the appropriate party.

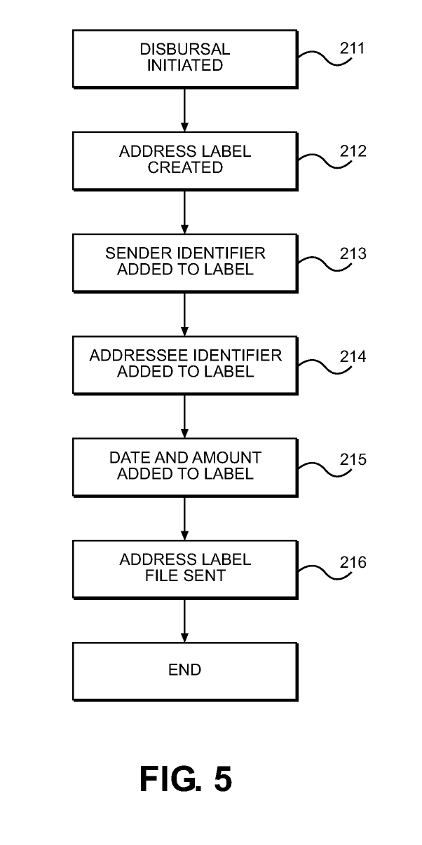

A detailed flow diagram of the disbursal process is shown in FIG. 5. Disbursal is initiated 211 by an administrative user such as a member of the Chief Financial Officer's staff. The administrative user interacts with the graphical user interface of the administrator interface in such a way as to create a new disbursement record. Basic information about the disbursal is entered or selected from on-screen representations of budget database entries. The date, amount of disbursal, intended recipient, sub-organizational information, and associated allotment information are added to the new disbursement record.

Once all initial disbursement information is entered, the system creates an address label 212. This may involve the generation of a new data file, or may involve the addition of a string of characters to the beginning of the disbursement record file. In a preferred embodiment, the address label is a string of characters inserted at the beginning of the disbursement record data file. This embodiment reduces the number of files that must be stored and tracked. Only one file must be sent at a time, which also reduces the likelihood of improper delivery of one of the two files, but not the other.

The administrator interface adds the sender's unique organizational identifier to the address label 213, then adds the addressee's unique organizational identifier 214, and lastly adds the date and disbursal amount 215 along with any other desired information. It is essential that this information is added in the same order to each address label. If contiguous information parcels are delineated, they must be delineated in the same manner in each address label. For example, the string “001-123-01012001-800000.00” could designate that the administrator's office, identified as 001, is sending the marketing department, identified as 123, money on Jan. 1, 2001, in the amount of 800,000.00. All address labels within this organization will have the format “senderID-addresseeID-mmddyyyy-amount.” Delineations need not be used so long as order of information chunks is strictly observed.

The address label is then finalized and sent to the addressee 216. In the preferred embodiment, this involves the transmission of the disbursement record with the address label inserted at the beginning of the file. In the alternative embodiment, the address label file is sent separate of the disbursement record, and the disbursement record is not attributed until the address label is checked for proper delivery.

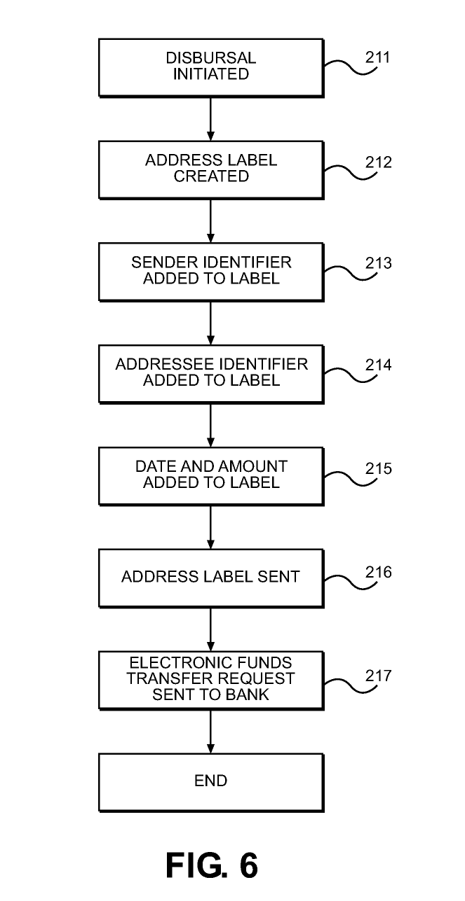

Another embodiment of the disbursal process is shown in FIG. 6. This flow diagram illustrates how an outside financial institution is incorporated into the disbursal. It is used in embodiments of the system where the organization utilizes multiple bank accounts that are associated with individual departments.

A disbursal 211 is initiated in the same manner as described above, and an address label similarly created 212. The sender's unique identifier is added to the label 213 as is the addressee's identifier 214, the date, amount and any other information 215. Once this is finalized, the address label is transmitted to the addressee 216. At the same time the address label and/or disbursement record are transmitted, an electronic funds transfer request is made 217 to the outside financial institution. The funds transfer requests that money be moved from the sender's bank account to the addressee's. To facilitate this request, bank accounts are stored within the system and associated with unique identifiers of departments. In this way, the creation of an address label also includes the query of the system for bank account information associated with the sender and the addressee.

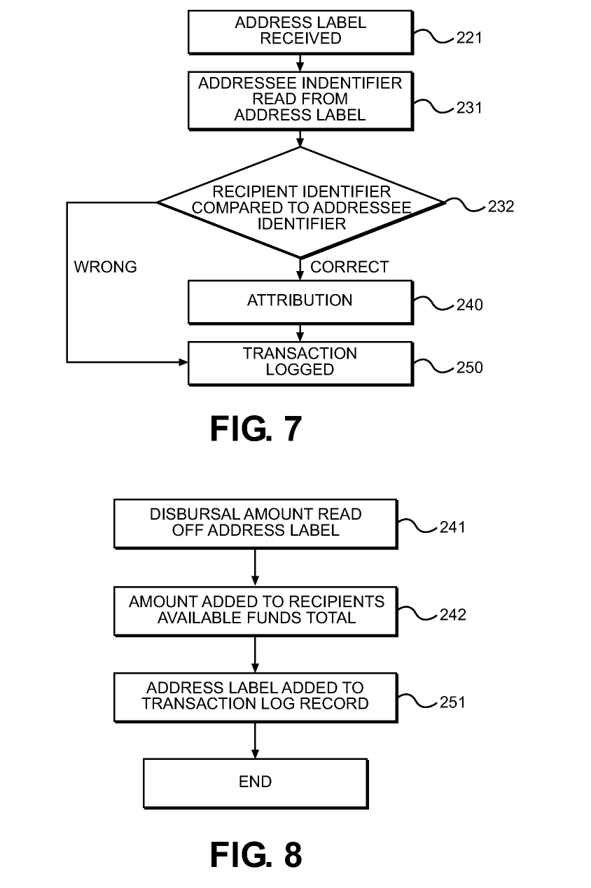

A simple embodiment of the error checking process is shown in the flow diagram of FIG. 7. This process is utilized in the embodiment of the system that does not require interaction with an outside financial institution.

Address labels are received 221 into the mailbox of the addressee as determined by the addressee identifier indicated on the address label. When the address label is sent, the system correlates the address identifier with a department and sends the file to that department's mailbox. The recipient's client interface then reads the addressee identifier of the address label file 231.

The addressee identifier is compared with the actual recipient's identifier 232 to determine if a match exists. If the identifiers are the same, then the funds are attributed to the recipient's available funds balance 240. If there is no match, the sender is notified of the delivery failure. The address label and/or disbursement record are added to the transaction database 250 in the event of correct or incorrect delivery. Administrators can set up notification preferences such that they receive information about where a disbursement was delivered and a budget reference number, thereby assisting them in looking up the proper recipient in the event of failed delivery.

Attribution in the general account system embodiment is easy, as is shown in FIG. 8. Once proper delivery is confirmed, the client interface reads the disbursement amount off the address label 241 and adds this amount to an available balance 242. The available balance for each department, project and individual employee are summed within the client interface. Every time a disbursal is accepted or expenditure is entered, the system updates the running total. Because attributions are logged in the transaction database 251, any suspected discrepancies in available balance can easily be figured out and addressed without the need for substantial investigation.

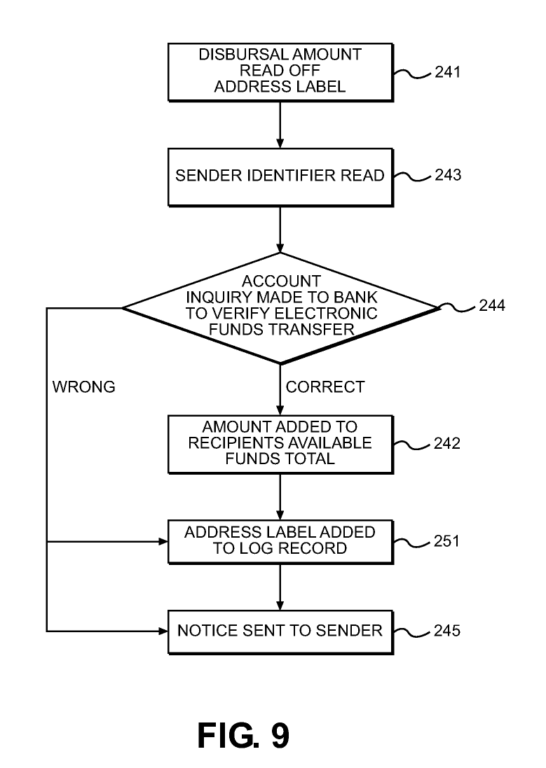

Turning to FIG. 9 there is shown an embodiment of the attribution process associated with the system in communication with outside financial institutions. As discussed above, FIG. 6 illustrates a disbursement ending with an electronic funds transfer request for transfer of funds from the sender's bank account to that of the addressee department. The attribution process of FIG. 9 is a continuation of the process of FIG. 6.

Disbursal amount information is read off the address label 241, along with the sender's identifier 243. The system will look up the sender and recipient bank accounts and then quest confirmation that the electronic funds transfer did occur between the two accounts 244. This may be in the form of an independent transaction history inquiry to the financial institution or may be an internal inquiry. In the case of internal inquiry, the system queries the transaction database for confirmation code issued by the financial institution regarding the requested transfer. It is thus necessary to store EFT request and confirmation information within the transaction database and associate this information with the sender and addressee bank accounts, so that proper verification can easily commence.

If the funds transfer is verified, then the appropriate available balance is updated 242. The transaction log is updated 251 and a notice may be sent to the sender 245. Transaction log updates includes information concerning the confirmation code of the electronic funds transfer. In the event that the transfer is not verified, the transaction log is update with the erroneous information and marked as a delivery failure. The sender is immediately notified so that the EFT can be reversed if necessary.

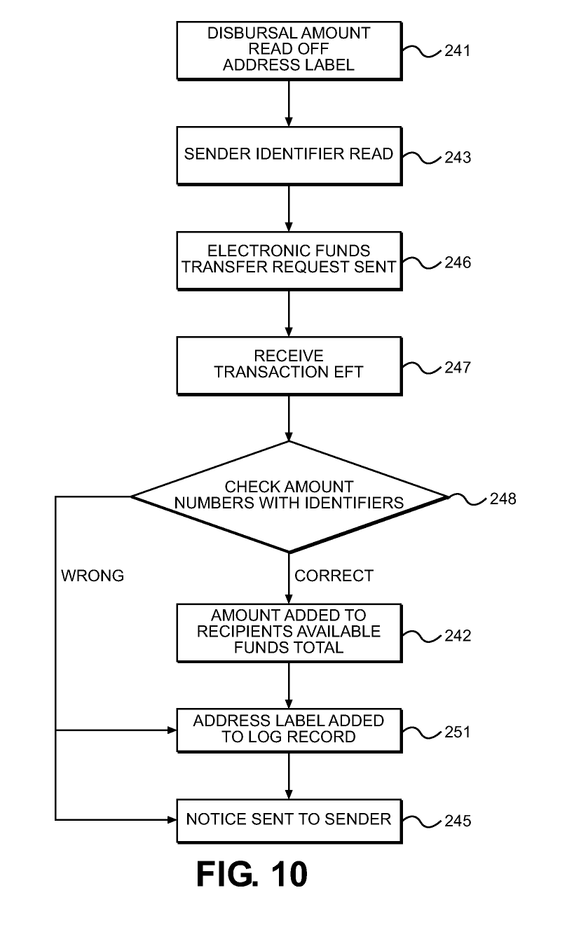

A final embodiment of the funds attribution process is shown in the flow diagram of FIG. 10. After the disbursal amount is read from the address label 241 along with the sender identifier 243, the system looks up the bank account information for both the sender and recipient. An electronic funds transfer request is then sent to the financial institution 246. The request indicates that funds in the amount disclosed on the address label should be moved from the sender's bank account to the addressee's account. An EFT transaction confirmation is then received from the bank 247.

The bank accounts associated with the transfer confirmation are checked against the sender and recipient bank account information to ensure proper transfer. If all accounts match, then the recipient's available balance is updated 242 and the transaction is logged within the transaction database 251. If the accounts do not match, the available funds balance is not updated and notice is sent to the sender immediately. Funds transfer information is also transmitted to the sender so that they can reverse the transaction if needed.

The present invention as described herein, is a disbursement tracking system for organizational accounting. Using package tracking principles, the system provides an address label that designates an intended recipient of funds disbursals. When funds are received by a department, the address is checked to ensure that delivery is proper. Funds are then attributed to the department and an available balance is updated. The funds can then be re-disbursed from the department to individual projects or employees. This may include the generation of a new address label or an appending of the previous one. By way of example, if the Chief Financial officer disburses funds to research and development for cancer research projects, the department can then re-disburse the money to different cancer research projects. If a new address label is created, it will be linked in the transaction database to the original address label so that a chain of custody is established over the lifecycle of the funds. If the original address label is merely amended, if will reflect the chain of custody when read by the final recipient and will be amended in the transaction database as disbursal occur. In this manner, the originator can track the use and distribution of the funds as they travel through the organization. Each step of the disbursal and attribution processes is repeated at each instance of re-disbursal. In this way, the system provides accurate record keeping and error keeping of funds usage throughout an organization and substantially alleviates the burden of reconciliation at the end of a fiscal period.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A disbursement tracking system for organizations, comprising:
a server;
one or more client workstations;
a network;
a software platform operating on said server and said one or more client computers and communicating therebetween over said network, wherein said software platform comprises comprising an administrator interface and one or more client interfaces, at least one database containing budget and transaction information;
a plurality of unique identifiers associated with departments of an organization;
said software platform uses said identifiers to assign a sender and addressee to a disbursal communication transmitted over said network, and wherein said software platform uses said identifiers to confirm delivery of said disbursal communication to an intended recipient.

2) The system of claim 1, wherein said disbursal communication contains information comprising a sender identifier, an addressee identifier, and a disbursal amount.

3) The system of claim 2, wherein said disbursal communication further comprises a budget proposal reference identifier.

4) The system of claim 1, wherein confirmed delivery results in an increased available funds balance associated with recipient's identifier.

5) The system of claim 1, wherein said client interface receives input regarding expenditures by a department linked to a unique identifier.

6) The system of claim 1, wherein said disbursal communication can be modified after receipt to include a second addressee, and said disbursal communication can be transmitted to said second addressee.

7) The system of claim 1, wherein delivery confirmations are added to said one or more databases, creating a disbursement history.

8) The system of claim 1, wherein a failure to confirm delivery results in a failed delivery notice being transmitted to a sender.
